(19) United States
(12) Patent Application Publication
(10) Pub. No.: US 2015/0181566 A1
(43) Pub. Date: Jun. 25, 2015

(54) APPARATUS AND METHOD FOR REDUCING UPSTREAM CONTROL CHANNEL RESOURCES IN A COMMUNICATIONS SYSTEM

(71) Applicant: Broadcom Corporation, Irvine, CA (US)

(72) Inventor: Daniel STOPLER, Holon (IL)

(73) Assignee: Broadcom Corporation, Irvine, CA (US)

(21) Appl. No.: 14/137,616

(22) Filed: Dec. 20, 2013

(51) Int. Cl. H04W 72/04; H04W 72/08

(52) U.S. Cl. CPC H04W 72/042; H04W 72/082

(57) ABSTRACT

A system and method for allocating one or more Physical downlink Control Channel (PDCCH) resource and correspondingly allocating one or more Physical Uplink Control Channel (PUCCH) resource within the PUCCH. The allocation of the one or more PUCCH resource can be based on the allocation of one or more previously allocated PUCCH resources within the PUCCH that are associated with one or more other mobile devices. For example, the allocation of the current PDCCH resource and corresponding PUCCH resource can include determining the interference between the current PUCCH resource and the one or more other PUCCH resources having been previously allocated. Based on the interference, a corresponding PDCCH resource can be re-allocated so as to re-allocate the current PUCCH resource.

### BACKGROUND

### Field

This application relates generally to wireless communications, including improving efficiency of uplink and/or downlink transmissions within a wireless communication environment.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates an example network environment.

FIG. 2 illustrates a base station according to an exemplary embodiment of the present disclosure.

FIG. 3 illustrates a configuration and operation of a scheduler according to an exemplary embodiment of the present disclosure.

FIG. 4 illustrates a flowchart of a scheduling method according to an exemplary embodiment of the present disclosure.

FIG. 5 is an example computer system according to an exemplary embodiment of the present disclosure.

The embodiments of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

For purposes of this discussion, the term “module” shall be understood to include one of software, firmware, hardware (such as circuits, microchips, processors, or devices, or any combination thereof), or any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

In the following disclosure, terms defined by the Long-Term Evolution (LTE) and/or LTE Advanced standards are sometimes used. For example, the term “eNodeB” or “eNB” is used to refer to what is commonly described as a base station (BS) or a base transceiver station (BTS) in other standards. The term “User Equipment (UE)” is used to refer to what is commonly described as a mobile station (MS) or mobile terminal in other standards. The LTE and LTE Advanced standards are developed by the 3rd Generation Partnership Project (3GPP) and described in the 3GPP TS 36.XXX standard titled “Evolved Universal Terrestrial Radio Access (E-UTRA); Physical layer procedures,” and the International Mobile Telecomunnications-2000 (IMT-2000) and IMT Advanced standards, all of which are incorporated by reference in their entirety.

As will be apparent to a person of ordinary skill in the art based on the teachings herein, exemplary embodiments are not limited to the LTE and/or LTE Advanced standards, and can be applied to other cellular communication standards, including (but not limited to) Evolved High-Speed Packet Access (HSPA+), Wideband Code Division Multiple Access (W-CDMA), CDMA2000, Time Division-Synchronous Code Division Multiple Access (TD-SCDMA), Global System for Mobile Communications (GSM), General Packet Radio Service (GPRS), Enhanced Data Rates for GSM Evolution (EDGE), and Worldwide Interoperability for Microwave Access (WiMAX) (IEEE 802.16) to provide some examples. Further, exemplary embodiments are not limited to cellular communication networks and can be used or implemented in other kinds of wireless communication access networks, including (but not limited to) Wi-Fi (IEEE 802.11), Bluetooth, Near-field Communication (NFC) (ISO/IEC 18092), ZigBee (IEEE 802.15.4), and/or Radio-frequency identification (RFID), to provide some examples. These various standards and/or protocols are each incorporated by reference in their entirety.

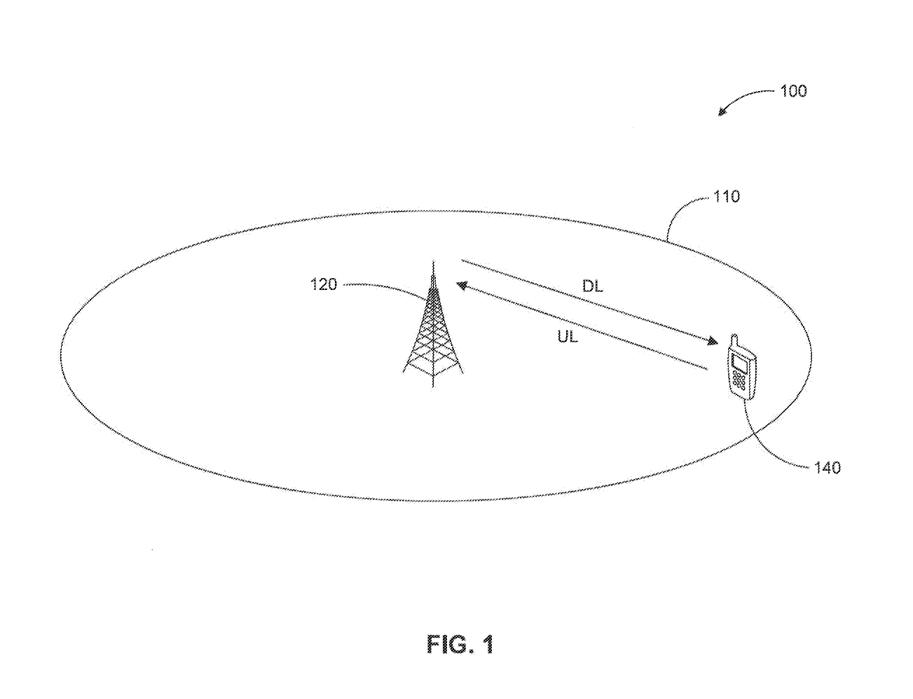

FIG. 1 illustrates an example communication environment 100 that includes a base station 120 and a mobile device 140. The base station 120 and the mobile device 140 each include suitable logic, circuitry, and/or code that is configured to communicate via more than one wireless technology (e.g., LTE, Advanced LTE, or the like). The mobile device 140 can include, for example, a transceiver having suitable logic, circuitry, and/or code that is configured to transmit and/or receive wireless communications via one or more wireless technologies within the communication environment 100.

The mobile device 140 communicates with the base station 120 in a serving cell or sector 110 of the communication environment 100. For example, the mobile device 140 receives signals on one or more downlink (DL) channels and transmits signals to the base station 120 on one or more uplink (UL) channels. Although exemplary embodiments are described with reference to LTE and/or LTE Advanced, the more generic terms “mobile device/terminal” and “base station” are used herein except where otherwise noted to refer to the LTE/Advanced LTE terms “User Equipment (UE)” and “eNodeB/eNB,” respectively. Further, for the purposes of this discussion, any reference to LTE refers to the LTE protocol, the LTE Advanced protocol, or a combination of both protocols unless otherwise noted.

Examples of the mobile device include (but are not limited to) a mobile computing device—such as a laptop computer, a tablet computer, a mobile telephone or smartphone, a “phablet,” a personal digital assistant (PDA), and the like; and a wearable computing device-such as a computerized wrist watch or “smart” watch, computerized eyeglasses, and the like. In some embodiments, the mobile device 140 may be a stationary, including, for example, a stationary computing device—such as a personal computer (PC), a desktop computer, a computerized kiosk, an automotive/aeronautical/maritime in-dash computer terminal, and the like.

In an exemplary embodiment, the communication environment 100 is configured to use time division duplex (TTD) and/or frequency division duplex (FDD), including, for example, Orthogonal Frequency Division Multiplexing (OFDM) in the downlink and Single-Carrier OFDM (SC-OFDM) in the uplink. The available radio resources in the communication environment 100 can be represented as a time-frequency grid that is divided into one millisecond subframes, where each subframe includes a number of OFDM symbols. Each subframe includes a control region and a data region that contain control information and data, respectively. Generally, for a normal cyclic prefix (CP) length, a subframe includes fourteen OFDM symbols. This is generally the case when multipath dispersion is not expected to be extremely severe. Alternatively, a subframe can include twelve OFDM symbols if an extended cyclic prefix is used. With respect to the frequency domain, the physical resources are divided into adjacent subcarriers with a spacing of 15 kHz. The number of subcarriers varies according to the allocated system bandwidth. A resource element (RE) is an element of the time-frequency grid that includes one OFDM subcarrier during one OFDM symbol interval.

In an exemplary embodiment, data is transmitted from the mobile device 140 to the base station 120 on a Physical Uplink Shared Channel (PUSCH) that is a time and frequency multiplexed channel shared by the mobile devices within the communication environment 100 (e.g., the mobile device 140 and one or more other mobile devices). Uplink transmissions are organized into 10 ms radio frames, where the radio frames include ten equally-sized subframes. For purposes of scheduling uplink transmissions, the time-frequency resources are allocated in units called resource blocks (RBs), where each resource block spans twelve adjacent subcarriers in the frequency domain, and one 0.5 ms time slot (one half of one subframe).

When the mobile device 140 has data to send on the uplink, the mobile device 140 sends a scheduling request to the base station 120 on a Physical Uplink Control Channel (PUCCH). A scheduler at the base station 120 coordinates transmissions by the mobile devices 140 on the PUSCH and allocates uplink resources to the mobile device 140 for uplink transmission on the PUSCH. The allocation can be based on the uplink scheduling request (SR) provided to the base station 120 within the PUCCH. The base station 120 then sends a scheduling grant to the mobile device 140 on the Physical Downlink Control Channel (PDCCH). Here, the scheduling grant can include the resource block allocation for the uplink transmission, and/or the modulation and/or coding scheme to be used for the uplink transmission. The mobile device 140 can then be configured to transmit data on the assigned uplink resources.

The PUCCH is used to control feedback signaling that is transmitted from the mobile device 140 to the base station 120, and contains control data, including, for example, (1) an acknowledgment signal (e.g., ACK/NAK signal) that indicates whether the downlink transmission was successful; (2) channel quality indicators (CQI) and rank indicators (RI) that report the downlink channel quality and MIMO ranking information for MIMO configurations; (3) a pre-coding matrix indication (PMI) that provides a suggested pre-coding matrix should be used by the base station 120 (e.g., for beam forming purposes); and (4) uplink scheduling requests (SR). Here, the CQI, RI, and PMI can have the same or different allocation within the PUCCH.

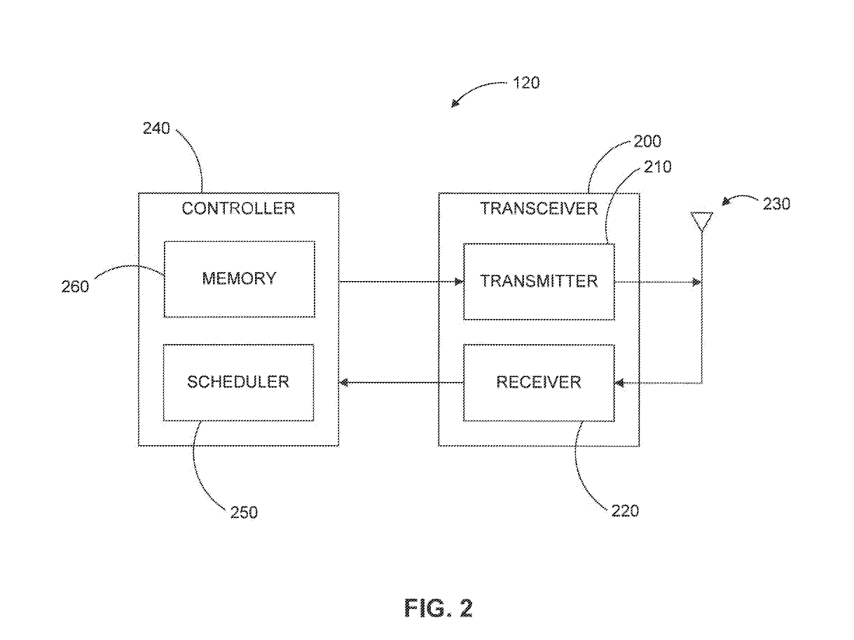

FIG. 2 illustrates the base station 120 according to an exemplary embodiment of the present disclosure. For example, the base station 120 can include a transceiver 200 communicatively coupled to a controller 240.

The transceiver 200 includes suitable logic, circuitry, and/or code that is configured to transmit and/or receive wireless communications via one or more wireless technologies (e.g., LTE and/or Advanced LTE) within the communication environment 100. In particular, the transceiver 200 can include a transmitter 210 and a receiver 220 that have suitable logic, circuitry, and/or code configured to transmit and receive wireless communications, respectively, via one or more antennas 230. Those skilled in the relevant art(s) will recognize that the antenna 230 may include an integer array of antennas, and that the antenna 230 may be capable of both transmitting and receiving wireless communication signals. For example, the base station 120 and/or the mobile device 140 can be configured for wireless communication utilizing a Multiple-input Multiple-output (MIMO) configuration.

The controller 240 includes suitable logic, circuitry, and/or code that is configured to control the overall operation of the base station 120, including the operation of the transceiver 200. The controller 240 can include one or more processors (CPUs) configured to carry out instructions to perform arithmetical, logical, and/or input/output (I/O) operations of the base station 120 and/or one or more components of the base station 120.

In an exemplary embodiment, the controller 240 includes a scheduler 250 and memory 260. The scheduler 250 includes suitable logic, circuitry, and/or code configured to coordinate transmissions by the one or more mobile devices 140 on the PUSCH and allocate uplink resources to the mobile devices 140 for uplink transmission on the PUSCH. The memory 260 includes suitable logic, circuitry, and/or code that can be configured to store information. The memory 260 can be any well-known volatile and/or non-volatile memory, including, for example, read-only memory (ROM), random access memory (RAM), flash memory, a magnetic storage media, an optical disc, erasable programmable read only memory (EPROM), programmable read only memory (PROM) and the like. The memory 260 can be non-removable, removable, or a combination of both.

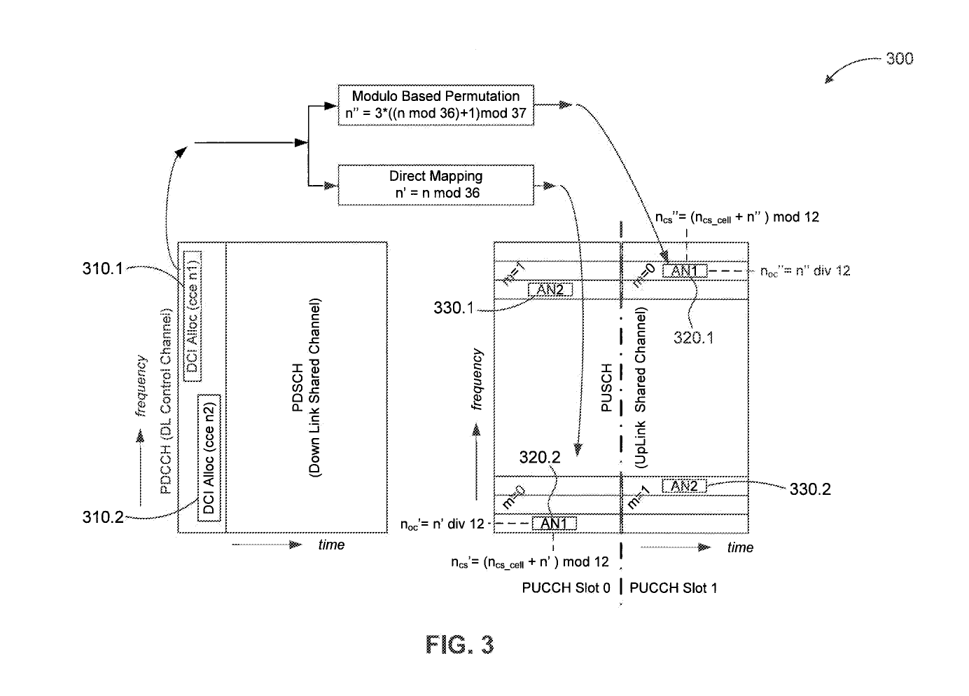

The scheduler 250 can be configured to coordinate transmissions by the mobile devices 140 on the PUSCH and allocate uplink resources to the mobile device 140 based on one or more scheduling requests (SR) provided to the base station 120 within the PUCCH. The scheduler 250 can be configured to then generate a scheduling grant, which is transmitted to the mobile device 140 on the PDCCH. Here, the scheduling grant can include the resource block allocation for the uplink transmission, and/or the modulation and/or coding scheme to be used for the uplink transmission. The mobile device 140 can then be configured to transmit data on the assigned uplink resources to the base station 120. In operation, the scheduler 250 is configured to allocate a resource block utilizing the PDCCH, including one or more downlink control indicators (DCIs) within the PDCCH that indicate the allocation of corresponding resource blocks for the uplink transmission. For example, as described in more detail below with respect to FIG. 3, the scheduler 250 can allocate uplink resources (e.g., resource blocks) within the PUCCH of the uplink transmission based on the allocation (e.g., location) of a DCI within the PDCCH. As will be understood by those skilled in the relevant art(s), the exemplary embodiments described herein can also be applied to the allocation of uplink resources within the PUCCH based on the allocation of DCI within an enhanced PDCCH (“ePDCCH”).

FIG. 3 illustrates an example operation 300 of the scheduler 250 according to an exemplary embodiment of the present disclosure.

In operation, the scheduler 250 is configured to allocate uplink resources within the PUCCH based on the allocation of one or more downlink control indicators (DCIs) 310 within the PDCCH. Here, each of the DCIs is associated with a channel control element (CCE) that corresponds to the time and frequency location within the PDCCH. This PDCCH CCE further corresponds to a PUCCH resource index n=CCE+β (where β is a predetermined offset as defined in the 3GPP 36.213 standard. See, Section 10.1 of the 3GPP 36.213 V10.3.0). Without loss of generality, and for the purposes of this disclosure, it is assumed that β=0. Therefore, by omitting β(β=0), n refers to both CCE and to the PUCCH resource index. That is, n refers to the CCE number as well as the PUCCH resource index (e.g., n=CCE+0). The scheduler 250 can be configured to allocate a PUCCH resource 320.1 to a corresponding first resource block in a first PUCCH allocation of the PUCCH resource index at a first frequency, and a PUCCH resource 320.2 to a corresponding second resource block in a second PUCCH allocation of the same PUCCH resource index at a second frequency. For example, the uplink channel can include a high frequency PUCCH allocation and a low frequency PUCCH, where the scheduler 250 can be configured to allocate the PUCCH resource 320.1 to the first resource block within the high frequency PUCCH allocation and the PUCCH resource 320.2 to the second resource block within the low frequency PUCCH allocation. Here, the PUCCH resource 320.2 corresponding to the second PUCCH allocation (e.g., at the low frequency) is associated with a PUCCH resource number n′ that corresponds to the time and frequency location within the PUCCH resource block corresponding to the PUCCH resource index at low frequency, and the PUCCH resource 320.1 corresponding to the first PUCCH allocation (e.g., at the high frequency) is associated with another PUCCH resource number n″ that corresponds to the other time and frequency location within the PUCCH resource block corresponding to same PUCCH resource index at high frequency. The PUCCH resource numbers n′ and n″ are values that are derived based on the PUCCH resource index.

In an exemplary embodiment, the memory 260 of the controller 240 includes one or more look-up tables (LUTs) configured to store one or more PUCCH resource index numbers (e.g., PUCCH resource indices) and/or PUCCH resource numbers (e.g., n′ and n″), and their respective time and frequency allocation locations. For example, a LUT within the memory 260 can include PUCCH resource index and corresponding PUCCH resource numbers n′ and n″ and their respective time and frequency allocation locations.

The PUCCH resource 320.1 allocation illustrated as AN1 is a part of the ACK/NAK element corresponding to the DCI 310.1. The DC 310.1 is located at the control channel element (CCE) within the PDCCH having a time and frequency allocation location corresponding to the PUCCH resource index number n₁=CCE+β (where it is assumed that β=0).

A pair of PUCCH resource blocks, one for high frequency and one for low frequency, are determined by dividing n; by the number of PUCCH resources in a PUCCH resource block. (See, Section 5.4.3 of 3GPP 36.213 V10.3.0). In an exemplary embodiment, the number of PUCCH resources in a PUCCH resource block is, for example, 36. However, the number of PUCCH resources is not limited to 36 and can be any number as would be understood by those skilled in the relevant art(s).

In an exemplary embodiment, the allocation of the PUCCH resource 320.1 within the PUCCH resource block is based on a modulo-based permutation of the n₁, which in turn is based on the CCE of DCI 310.1, while the allocation of the PUCCH resource 320.2, which is the other part of ACK/NAK element also corresponding to the DCI 310.1, is allocated within the PUCCH resource block based on a direct mapping of n₁, which in turn is based on the CCE of DCI 310.1.

As shown in FIG. 3, the scheduler 250 is configured to allocate PUCCH resources within the PUCCH in a first time slot (e.g., slot 0) and a time second slot (e.g., slot 1) within the PUCCH that correspond to the allocation of DCIs 310 within the PDCCH. However, one of ordinary skill in the relevant art(s) will understand that the number of time slots is not limited to the number shown in FIG. 3, and more or less time slots can be utilized without departing from the spirit and scope of the present disclosure. Further, one of ordinary skill in the relevant art(s) will understand that because all even time slots and all odd time slots are utilized and configured in the same or similar manner, two time slots are illustrated and discussed for brevity.

In an exemplary embodiment, the scheduler 250 can be configured to allocate two PUCCH resources 320.1 and 320.2 based on a single DCI 310.1, and similarly allocate resource blocks 330.1 and 330.2 based on DCI 310.2. For the purposes of this discussion, the operation of the scheduler 250 will be described with respect to only the allocation of PUCCH resources 320 based on the DCI 310.1, as the allocation of the resource blocks 330 are performed in the same or similar manner. Further, the discussion of the allocation of PUCCH resources by the scheduler 250 assumes that the time spacing of the PUCCH resources (e.g., PUCCH delta cyclic shift) is such that a desired PUCCH allocation density is achieved. In an exemplary embodiment, the PUCCH allocation density can have a PUCCH delta cyclic shift value (e.g., Δ_{shift}^{PUCCH}) equal to 1. Here, where the Δ_{shift}^{PUCCH}=1, the maximum PUCCH allocation density is achieved. Another assumption for the purposes of this discussion is that the PUCCH does not contain channel quality indicators (CQI). The absence of channel quality indicators (CQI) can be represented as nRB−CQI=0, where nRB−CQI is the number of PUCCH resources allocated for CQIs. It should be appreciated that the PUCCH delta cyclic shift is not limited to the exemplary values described herein, and the PUCCH delta cyclic shift can be any PUCCH delta cyclic shift value as understood to one of ordinary skill in the relevant art(s). Further, one of ordinary skill in the relevant art(s) will understand that the present disclosure can include implementations in which the PUCCH includes one or more CQIs, and that the assumptions made in the present disclosure are made to ease in the discussion of the exemplary embodiments.

The scheduler 250 can be configured to allocate the PUCCH resources 320 utilizing a direct mapping process and/or a modulo-based permutation process based on an allocation of a DCI within the PDCCH-. Further, the number of PUCCH resource blocks needed is determined such that the following is satisfied:

N_{RB}=N_{CCE}×M×Δ_{shift}^{PUCCH}/36

Where N_{RB} is the number of the PUCCH resource blocks, N_{CCE} is the size of the PDCCH, M is the number of downlink subframes corresponding to a single uplink subframe, where 1≦M≦9 (e.g., where M=9, one uplink frame is associated with nine downlink subframes), and Δ_{shift}^{PUCCH} is the PUCCH delta shift of the PUCCH. Here, decreasing the Δ_{shift}^{PUCCH} can reduce the number of PUCCH resource blocks (NRA) required for ACK/NAK elements, and thereby reducing waste of Uplink resource blocks. In the above equation, the Δ_{shift}^{PUCCH} is divided by 36, which corresponding to the number of PUCCH resources in a PUCCH resource block. However, the number of PUCCH resources is not limited to 36 and can be any number as would be understood by those skilled in the relevant art(s).

In utilizing the direct mapping process, the scheduler 250 is configured to allocate the PUCCH resource at a time and frequency location associated with the PUCCH resource number n′, where n′ is based on the allocation index number n corresponding to the DCI on which such allocation is based. That is, the scheduler 250 is configured to determine the value of the allocation index number n associated with the DCI 310.1 and to allocate the PUCCH resource 320.2 to the time and frequency location associated with the PUCCH resource number n′, where the value of the PUCCH resource number n′ satisfies the following equation:

n′=n modulo 36

Again, n is the allocation index number corresponding to the DCI on which such allocation is based. In the above equation, 36 corresponds to the number of PUCCH resources in a PUCCH resource block. The number of PUCCH resources is not limited to 36 and can be any number as would be understood by those skilled in the relevant art(s).

For example, the scheduler 250 can be configured to determine the allocation index number n associated with the time and frequency location of the DCI 310.1. Here, the scheduler 250 can read data stored in the memory 260 (e.g., data stored in a look-up table (LUT) within the memory 260). For example, the scheduler 250 can determine a time and frequency location within a LUT associated with DCI allocations whose time and frequency location matches the time and frequency location of DCI 310.1. The scheduler 250 can then read the allocation index number n that corresponds to the matched time and frequency location. Following the determination of the allocation index number n, the scheduler 250 can find the PUCCH resource number n′ within a LUT associated with PUCCH resource allocations whose PUCCH resource index matches the allocation index number n. The scheduler 250 can then read the time and frequency location corresponding to the PUCCH resource number, and allocate the PUCCH resource 320.2 utilizing this time and frequency location. In an exemplary embodiment, scheduler 250 is configured to perform the direct mapping process utilizing a modulus function such that n′=n mod 36 as described above.

In utilizing the modulo-based permutation process, the scheduler 250 is configured to allocate the PUCCH resources using one or more modulo-based permutation functions. For example, the scheduler 250 is configured to allocate the PUCCH resource within the PUCCH (e.g., PUCCH resource 320.1) at a time and frequency location associated with the PUCCH resource number n″, where the PUCCH resource number n″ is determined based on one or more modulo-based permutation functions of the allocation index n. Again, the allocation index number n corresponds to the time and frequency location of the DCI 310.1 within the PDCCH. The scheduler 250 can determine the allocation index number n using the LUT associated with DCI allocations as discussed above with the direct mapping process. The scheduler 250 can then determine the PUCCH resource number n″ using one or more modulo-based permutation functions of the allocation index number n. In an exemplary embodiment, the scheduler 250 is configured to utilize a modulo-based permutation function of the allocation index number n that satisfies the following:

n″=3((n mod 36)+1)mod 37

The modulo-based permutation process is not limited to the exemplary modulo-based permutation process discussed above, and the process can be any well-known modulo-based permutation process as will be understood by those of ordinary skill in the relevant arts.

Following determination of the PUCCH resource number n″, the scheduler 250 can determine the time and frequency location corresponding to the determined PUCCH resource number n″ using the LUT associated with PUCCH resource allocations. The scheduler 250 can then allocate the PUCCH resource 320.1 utilizing this determined time and frequency location.

In the modulo-based permutation allocation, the scheduler 250 allocates the PUCCH resource 320.1 such that the cyclic shift (n_{cs}″) and the orthogonal cover sequence (n_{oc}″) satisfy the following respective equations:

n_{cs}″=(n_{cs}_{_{—}}_{cell}+n″)mod 12

n_{oc}″=n″ div 12

Where n_{cs}_{_{—}}_{cell} is the based cyclic shift associated with the cell.

Similarly, in the direct mapping allocation, the scheduler 250 allocates the PUCCH resource 320.2 such that the cyclic shift (n_{cs}″) and the orthogonal cover sequence (n_{oc}″) satisfy the following respective equations:

n′_{cs}=(n_{cs}_{_{—}}_{cell}+n′)mod 12

n_{oc}′=n′ div 12

Where n_{cs}_{_{—}}_{cell} is the based cyclic shift associated with the cell.

In an exemplary embodiment, the scheduler 250 is configured to allocate the PUCCH resources based on one or more PUCCH resources previously allocated within the PUCCH for one or more other mobile devices within the communication environment 100. In particular, the scheduler 250 is configured to determine and/or analyze the corresponding locations of one or more previously allocated PUCCH resources within the PUCCH. For example, the scheduler 250 can be configured to determine the locations by searching for previously allocated PUCCH resources within the PUCCH. The determined locations can be stored in any well-known memory within the base station 120 and/or mobile device 140, and retrieved by the scheduler 250 to be utilized in the allocation of a current PUCCH resource. For example, the locations can be stored in memory 260 within the controller 240.

Based on the determined location(s), the scheduler 250 can be configured to allocate a current PUCCH resource so as to reduce or eliminate interference between the mobile device 140 and one or more other mobile devices within the communication environment 100. In particular, because the allocation of the PUCCH resource is dependent on the allocation of a corresponding DCI within the PDCCH, the scheduler 250 can be configured to schedule the allocation of the DCI within the PDCCH to control the allocation of the corresponding allocation of the PUCCH resource within the PUCCH. For example, the scheduler 250 can be configured to schedule the allocation of the DCI within the PDCCH so that the allocation of the PUCCH resource within the PUCCH results in a reduction and/or elimination of interference between one or more previously allocated PUCCH resources within the PUCCH resource block and the currently allocated PUCCH resource.

By scheduling the allocation of the DCI as described herein, the scheduler 250 can be configured to use an increased PUCCH allocation density (e.g., a reduced PUCCH delta cyclic shift) while achieving a reduction and/or elimination of interference between allocated PUCCH resources. For example, the scheduler 250 can configured to have a PUCCH delta cyclic shift (Δ_{shift}^{PUCCH}=1) rather than a larger PUCCH delta cyclic shift (e.g., Δ_{shift}^{PUCCH}≧2) generally used in conventional communication environments. As will be appreciated by those of ordinary skill in the relevant art(s), the PUCCH delta shift cyclic value (Δ_{shift}^{PUCCH}) has an inverse relationship to the PUCCH allocation density. That is, a decrease in the PUCCH delta cyclic shift value results in an increase in the PUCCH allocation density. Here, the PUCCH allocation density refers to the time spacing between PUCCH resources within the PUCCH. For example, a reduction of the PUCCH delta cyclic shift (i.e., an increase in the PUCCH allocation density) results in a decrease in the time spacing between PUCCH resources within the PUCCH.

That is, in operation of an exemplary embodiment, the scheduler 250 can be configured to allocate the PUCCH resources 320 utilizing a direct mapping process and/or a modulo-based permutation process based on the allocation of a DCI 310 within the PDCCH while utilizing one or more previous allocations of PUCCH resources 320 within the PUCCH. Here, the scheduler 250 is configured to adjust the allocation of the DCI 310 so that the direct-mapped allocation and/or modulo-based permutated allocation of the PUCCH resource 320 reduces and/or eliminates interference between the currently allocated PUCCH resource 320 and the one or more previously allocated PUCCH resources 320. For example, in operation, the scheduler 250 can be configured to recursively calculate the allocation of the PUCCH resource 320 (using the direct mapping process and/or a modulo-based permutation process) based on a recursively-adjusted allocation of DCI 310, and determine if the allocation of the PUCCH resource 320 results in the reduction and/or elimination of interference between one or more other PUCCH resources associated with one or more other mobile devices 140. In determining whether interference has been reduced and/or eliminated, the scheduler 250 can be configured to determine the location (e.g., time and/or frequency location) of the PUCCH resource 320 within the PUCCH and the location of the one or more previously allocated resource 320, and to determine (e.g., measure, calculate, etc.) an interference value corresponding to the interference (e.g., inter-symbol interference) between the current PUCCH resource 320 and the one or more previously allocated PUCCH resources 320 using any well-known signal processing technique. The scheduler 250 can be configured to compare the interference value to a predetermined interference threshold value to determine if the one or more previously allocated PUCCH resources 320 interferes with the current allocation of the PUCCH resource 320. For example, if the interference value is equal to or greater than the interference threshold value, the scheduler 250 determines the presence of interference. Based on the interference determination, the scheduler 250 is configured to determine which allocations (e.g., which locations) within the PUCCH will result in an interference value that is less than the interference threshold value, thereby resulting in the reduction and/or elimination of interference between the one or more previously allocated PUCCH resources 320 and the currently allocated PUCCH resource.

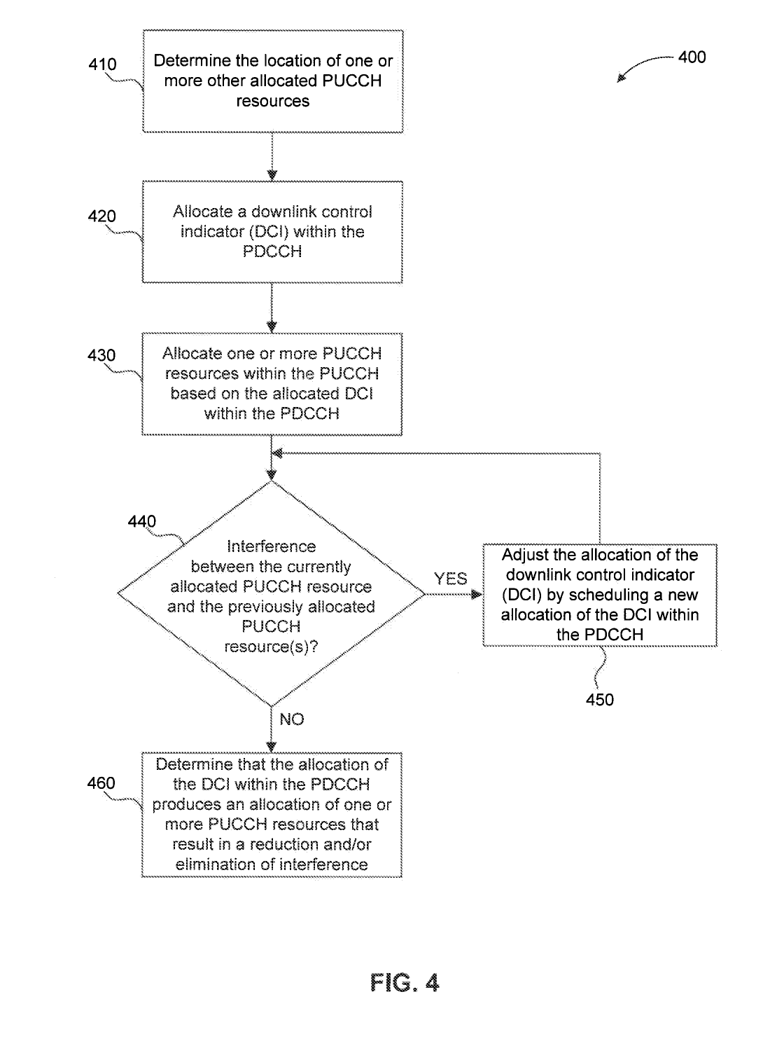

FIG. 4 illustrates a flowchart 400 of a scheduling method in accordance with an exemplary embodiment of the present disclosure. The method of flowchart 400 is described with continued reference to FIGS. 1-3. The steps of the method of flowchart 400 are not limited to the order described below, and the various steps may be performed in a different order. Further, two or more steps of the method of flowchart 400 may be performed simultaneously with each other.

The method of flowchart 400 begins at step 410, where the base station 120 is configured to determine and/or analyze the allocation (e.g., time and/or frequency location) of one or more other allocated PUCCH resources within the PUCCH that are associated with one or more other mobile devices within the communication environment 100. For example, scheduler 250 is configured to determine and/or analyze the corresponding locations of one or more previously allocated PUCCH resources within the PUCCH. In an exemplary embodiment, the scheduler 250 is configured to determine the locations by searching for previously allocated PUCCH resources within the PUCCH.

After step 410, the flowchart 400 transitions to step 420, where the base station 120 is configured to schedule the allocation of a downlink control indicator (DCI) within the PDCCH. For example, the scheduler 250 is configured to schedule the allocation of the DCI within the PDCCH based on availability of pending downlink data.

After step 420, the flowchart 400 transitions to step 430, where the base station 120 is configured to allocate one or more PUCCH resources within the PUCCH based on the allocated DCI within the PDCCH. For example, the scheduler 250 is configured to allocate the PUCCH resource 320 utilizing a direct mapping process and/or a modulo-based permutation process based on the allocation of the DCI 310 within the PDCCH.

After step 430 the flowchart 400 transitions to step 440, where the base station 120 is configured to determine and/or analyze interference between the currently allocated PUCCH resource (e.g., PUCCH resource 320) and the one or more previously allocated PUCCH resources within the PUCCH. For example, the base station 120 is configured to compare the allocation (e.g., time and/or frequency location) of the currently allocated PUCCH resource with the allocations of one or more previously allocated PUCCH resources within the PUCCH, and determine if the allocation of the currently allocated PUCCH resource results in interference between the one or more previously allocated PUCCH resources. In an exemplary embodiment, the scheduler 250 is configured to determine an interference value using any well-known signal processing technique, and compare the determined interference value to a predetermined interference threshold value.

If the base station 120 determines that the currently allocated PUCCH resource results in interference (YES at step 440), the flowchart 400 transitions to step 450, where the base station 120 is configured to adjust the allocation of (e.g., re-allocate) the downlink control indicator (DCI) by scheduling a new allocation of the DCI within the PDCCH. For example, the scheduler 250 is configured to adjust the allocation of the DCI 310 by scheduling a new allocation of the DCI 310 within the PDCCH. Here, because the allocation of the PUCCH resource 320 is dependent on the allocation of the corresponding DCI 310 within the PDCCH, the scheduler 250 is configured to re-allocate the DCI 310 within the PDCCH so as to re-allocate the corresponding PUCCH resource 320 within the PUCCH.

Following step 450, the flowchart 400 returns to step 440 so as to recursively perform an interference determination (at step 440), and if interference remains, perform another re-allocation of the DCI within the PDCCH at step 450.

If the base station 120 determines that the currently allocated PUCCH resource does not result in interference (NO at step 440), the flowchart 400 transitions to step 460, where the base station 120 is configured to determine that the allocation of the DCI within the PDCCH produces an allocation of one or more PUCCH resources that result in a reduction and/or elimination of interference with one or more previously allocated PUCCH resources within the PUCCH. For example, the scheduler 250 is configured to determine that the allocation of the DCI 310 and a corresponding PUCCH resource 320 results in the reduction and/or elimination of interference while achieving an increased PUCCH allocation density (e.g., Δ_{shift}^{PUCCH}=1). Following the determination of the allocation of the PUCCH resource 320, the controller 240 can be configured to send a message (via the transceiver 200) to the mobile device 140 identifying the PUCCH resource 320 that has been allocated to the mobile device 140.

Following step 460, the flowchart 400 returns to step 410 to perform the scheduling method for another downlink control indicator (DCI), or the flowchart 400 ends.

### Example Computer System

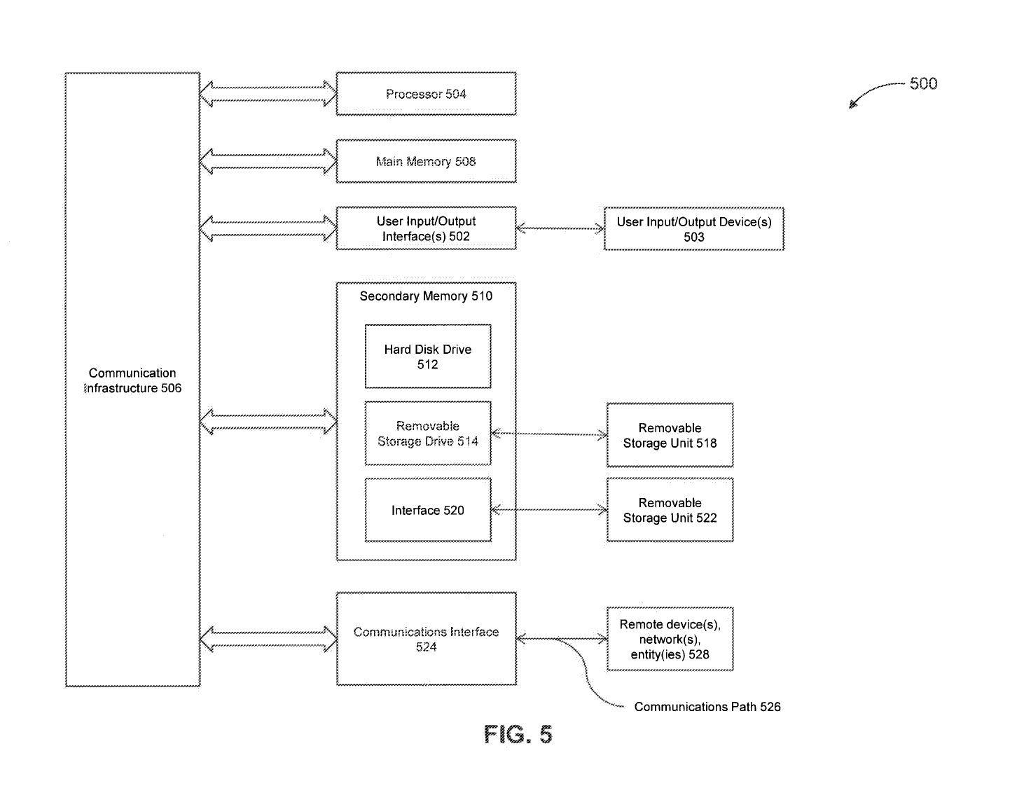

Various exemplary embodiments described herein can be implemented, for example, using one or more well-known computer systems, such as computer system 500 shown in FIG. 5. Computer system 500 can be any well-known computer capable of performing the functions described herein, such as computers available from International Business Machines, Apple, Sun, HP, Dell, Sony, Toshiba, etc.

Computer system 500 includes one or more processors (also called central processing units, or CPUs), such as a processor 504. Processor 504 is connected to a communication infrastructure or bus 506.

One or more processors 504 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 500 also includes user input/output device(s) 503, such as monitors, keyboards, pointing devices, etc., which communicate with communication infrastructure 506 through user input/output interface(s) 502.

Computer system 500 also includes a main or primary memory 508, such as random access memory (RAM). Main memory 508 may include one or more levels of cache. Main memory 508 has stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

In an embodiment, a tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 5. In particular, embodiments may operate with software, hardware, and/or operating system implementations other than those described herein.

### CONCLUSION

The aforementioned description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the specification is not meant to limit the invention. Rather, the scope of the invention is defined only in accordance with the following claims and their equivalents. In addition, the terminology used herein is for the purpose of describing particular embodiments only and is not intended to be limiting. For example, as used herein, the singular forms “a,” “an” and “the” are intended to include the plural forms as well, unless the context clearly indicates otherwise. It will be further understood that the terms “comprises,” “comprising,” “includes” and “including,” when used herein, specify the presence of stated features, integers, steps, operations, elements, and components, but do not preclude the presence or addition of one or more other features, integers, steps, operations, elements, components, or groups thereof.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and the like. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

The present disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

What is claimed is:

1. A communication device, comprising:
a transceiver configured to communicate via a communication path; and
a controller communicatively coupled to the transceiver, and configured to:
analyze a first Physical Uplink Control Channel (PUCCH) resource that has been previously allocated to a first mobile device; and
allocate a Physical Downlink Control Channel (PDCCH) resource to a second mobile device based on the analysis of the first PUCCH resource.

2. The communication device of claim 1, wherein the controller is configured to allocate a second PUCCH resource to the second mobile device based on the allocated PDCCH resource.

3. The communication device of claim 2, wherein the controller is configured to perform a direct-mapping allocation of the second PUCCH resource based on the allocated PDCCH resource.

4. The communication device of claim 2, wherein the controller is configured to perform a modulo-based permutation allocation of the second PUCCH resource based on the allocated PDCCH resource.

5. The communication device of claim 2, wherein the controller is configured to perform a direct-mapping allocation and a modulo-based permutation allocation of the second PUCCH resource based on the allocated PDCCH resource.

6. The communication device of claim 1, wherein the controller is configured to determine an interference value between the second PUCCH resource and the first PUCCH resource.

7. The communication device of claim 6, wherein the controller is configured to re-allocate the PDCCH resource based on the determined interference value.

8. The communication device of claim 7, wherein the controller is configured to re-allocate the second PUCCH resource based on the re-allocated PDCCH resource.

9. The communication device of claim 6, wherein the controller is configured to compare the determined interference value to an interference threshold value.

10. The communication device of claim 9, wherein the controller is configured to determine an allocation of the second PUCCH resource based on the comparison of the determined interference value and the interference threshold value.

11. A communication method, comprising:
analyzing a first Physical Uplink Control Channel (PUCCH) resource that has been previously allocated to a first mobile device; and
allocating a Physical Downlink Control Channel (PDCCH) resource to a second mobile device based on the analysis of the first PUCCH resource.

12. The communication method of claim 11, further comprising:
allocating a second PUCCH resource to the second mobile device based on the allocated PDCCH resource.

13. The communication method of claim 12, wherein allocating the second PUCCH resource comprises:
performing a direct-mapping allocation of the second PUCCH resource based on the PDCCH resource.

14. The communication method of claim 12, wherein allocating the second PUCCH resource comprises:
performing a modulo-based permutation allocation of the second PUCCH resource based on the PDCCH resource.

15. The communication method of claim 12, wherein allocating the second PUCCH resource comprises:
performing a direct-mapping allocation and a modulo-based permutation allocation of the second PUCCH resource based on the PDCCH resource.

16. The communication method of claim 13, further comprising:
determining an interference value between the second PUCCH resource and the first PUCCH resource.

17. The communication method of claim 16, further comprising:
re-allocating the PDCCH resource based on the determined interference value.

18. The communication method of claim 17, further comprising:
re-allocating the second PUCCH resource based on the re-allocated PDCCH resource.

19. The communication method of claim 11, wherein the analyzing of the first PUCCH resource comprises:
determining an interference value between the first PUCCH resource and a second PUCCH resource allocated to the second mobile device; and
comparing the interference value to an interference threshold value, wherein the allocation of the PDCCH resource is based on the comparison; and
wherein the method further comprises allocating the second PUCCH resource based on the allocation of the PDCCH resource.

20. A communication device, comprising:
a transceiver configured to communicate via a communication path; and
a scheduler configured to:
allocate a first resource within a Physical Downlink Control Channel (PDCCH);
allocate a second resource within a Physical Uplink Control Channel (PUCCH) based on the allocation of the first resource;
determine an allocation of a third resource within the PUCCH;
determine an interference value between the third resource and the second resource within the PUCCH;
re-allocate the first resource within the PDCCH based on the determined interference value.
